(19) United States
(12) Patent Application Publication
(10) Pub. No.: US 2013/0201668 A1
(43) Pub. Date: Aug. 8, 2013

(54) Device has LED means with extendable construction and added functions

(71) Applicant: Tseng-Lu Chien, Walnut, CA (US)

(72) Inventor: Tseng-Lu Chien, Walnut, CA (US)

(21) Appl. No.: 13/367,758

(22) Filed: Feb. 7, 2012

(51) Int. Cl. F21L 4/02

(52) U.S. Cl. 362/183

(57) ABSTRACT

An LED device has an extendable construction and added function(s). For example, the LED device may fit into a lamp fixture and or holder like a conventional light bulb, but include parts which extend, collapse, retract, and so forth for carrying out a variety of different functions, such as sensing or camera functions, as well as illumination functions.

The current invention is Continuously filing for Ser. No. 13/295,301 “The Device has build-in Digital Data means and Powered by unlimited power source of light device”.

The current invention is Continuously filing for Ser. No. 13/296,508 “ The Device has build-in Digital Data means and power unlimited power source of LED Bulb”

The current invention is continuously filing for Ser. No. 13/296,460 “The device has build-in Digital data means and powered by unlimited power source of Lamp Holder.

These (3) co-pending filing are Continuously filing of Ser. No. 12/951,501 “Lamp Holder has build-in LED Night light”

The current invention is continuously filing for Ser. No. 12/950,017 “Multiple surface LED light”

All these are Continuously filing for Ser. Nos. 13/296,508, 13/295,301, 13/296,469 are continuously filing for Ser. No. 13/162,824 Light device with display means has track-means and removable LED-unit(s) which are the continuously filing for Ser. No. 12/938,628 LED light fixture has outlet(s) and removable LED unit(s) and for Ser. No. 12/887,700 Light fixture with self-power removable LED unit(s). Those are continuously filing for Ser. No. 12/149,963 (Now patented U.S. Pat. No. 7,722,230), Ser. No. 12/073,095 (Now patented U.S. Pat. No. 7,726,869), Ser. No. 12/073,889 (Co-Pending Filing), Ser. No. 12/007,076 (Now patented U.S. Pat. No. 7,726,841), Ser. No. 12/003,691 (Now Patented U.S. Pat. No. 7,726,839), Ser. No. 12/894,865 (Co-Pending Filing).

### BACKGROUND

The other prior art such as U.S. Pat. No. 7,524,089 Park, U.S. Pat. No. 6,499,860 Begemann(Philips), U.S. Pat. No. 6,220,722 Begemann(Philips), U.S. Pat. No. 5,924,784 Chliwnyj et al, US 2003/0185 020 Stekelenburg, US 2006/0146 527 Vanderschuit, U.S. Pat. No. 6,648,496 Elghoroury, All these prior arts has no one has extendable constructions and more than one added functions for the said LED Bulb, Lamp Holder, Lamp Holder Adaptors which can overcome the block-means to make light beam or electric signal to transmitting and receiving.

From Market place, There had some application for Lamp Holder has variety functions or LED light bulb has variety of functions. There is no any products which has build-in Both LED light and Lamp holder with added functions including any combination of the following functions including (1) Motion Sensor (2) Remote Controll (hereafter as RF) (3) Blue tooth remote control (4) Timer (5) Countdown (6) 7 days programmable timer (7) multiple areas illuminations (8)

Or . . . electric functions available from market place to make the said LED light means to turn on and turn-off during certain functions, duration, Color, Brightness, focus, performance with optional parts & accessories.

The current invention preferred incorporated desired group combination from the selected parts and accessories to make the body glows light effects lamp holder or Body glows LED bulbs with extendable bars to install the desired parts and accessories including:

(a) plug parts of lamp holder or lamp holder Adaptor to connect with power source to get power.

(b) Multiple parts for illumination area(s)

(c) Extendable piece(s) in geometric shape and size.

(d) Stopper means in geometric shape and size to make stop of extendable piece(s)

(e) Energy storage means for DC energy such as rechargeable or regular batteries.

(f) LED-unit(s) and LED-assembly(s) for desired brightness and size and shape

(g) Circuit means for variety design for desired function(s)

(h) Conductive means and related parts & accessories for delivery electric signal

(i) Construction parts for fit the related mechanical or electric parts & accessories within

(j) motion sensor means

(k) remote control means

(l) blue tooth remote control means

(m) timer means

(n) count down means

(o) 7 days programmable timer means

(p) other switch means or sensor means

(q) Integrated Circuit means (Hereafter as IC)

(r) Digital data record and storage means

(s) Optics means including all kind of lens, stencil, windows, opening, cut-outs, reflective lens, Retro-reflective lens, opaque lens, condense lens, convex lens, concave lens or adjustable focus means lens, or any other optics means apply to LEDs light means

(t) heat sink to make the LEDs heat can be ventilate out of unit

(u) receiving parts & accessories of lamp holder or Lamp Holder Adaptor

(v) BODY parts for transparent, translucent, opaque, anti-flammable

(w) heat isolating means

(x) light block-out means

(y) switch means or sensor means available from market place

(z) linkable means to make multiple LED lights or Lamp Holders for illumination at the same time.

The current invention has Extendable piece(s) to overcome the some lighting fixture's lamp shade, lamp glass, lamp cover which normally designed for incandescent bulb and cover the incandescent bulb ugly shape. The Extendable piece(s) are necessary to allow the said designed lamp-holder or said LED Bulbs can had extra space to install the said “Added Function” without been blocked by the said lamp-shade, lamp-glass, lamp cover or whatever which block-out the light means. The current invention items had such EXTENDABLE PIECE(S) as necessary main construction for LED Bulb or

Lamp Holder(s) or Lamp Holder Adaptor(s).

The current invention's EXTENDABLE PIECE(s) can design on rear end for plug parts of lamp holder or lamp holder adaptor to get the power from the power source. It also can design for front of the Lamp Bulb to make the sensor means or switch means or receiving means of RF to get electric signal over the block-means of lamp shade, lamp cover, lamp glass . . . etc.

This is the main features of current invention of (1) LED Bulb (2) Lamp Holder (3) Lamp Holder Adaptor to overcome the block-means to make LED Bulb, Lamp Holder, Lamp Holder Adaptor can add “Extra Functions” without block out by Lamp Shade, Lamp Cover, Lamp Glass . . . etc.

The definition for the LED Bulb of current invention which has extendable piece to allow put the LED Bulb overcome the block-means. The LED Bulb are connect with Lamp Holder or Lamp Holder Adaptor to get get power for illumination.

The definition for the Lamp Holder of current inventions which has extendable piece to allow the Lamp holder overcome the block-means. The Lamp Holder one end connect with the House Electricity system, One end connect with light-source means.

The definition for the Lamp Holder Adaptor of current invention which has extendable piece to allow the lamp holder adaptor overcome the block means and the said added function are within the said Body parts. The Lamp Holder Adaptor one end connect with existing lamp Holder, One end connect with light-source means.

### DRAWING

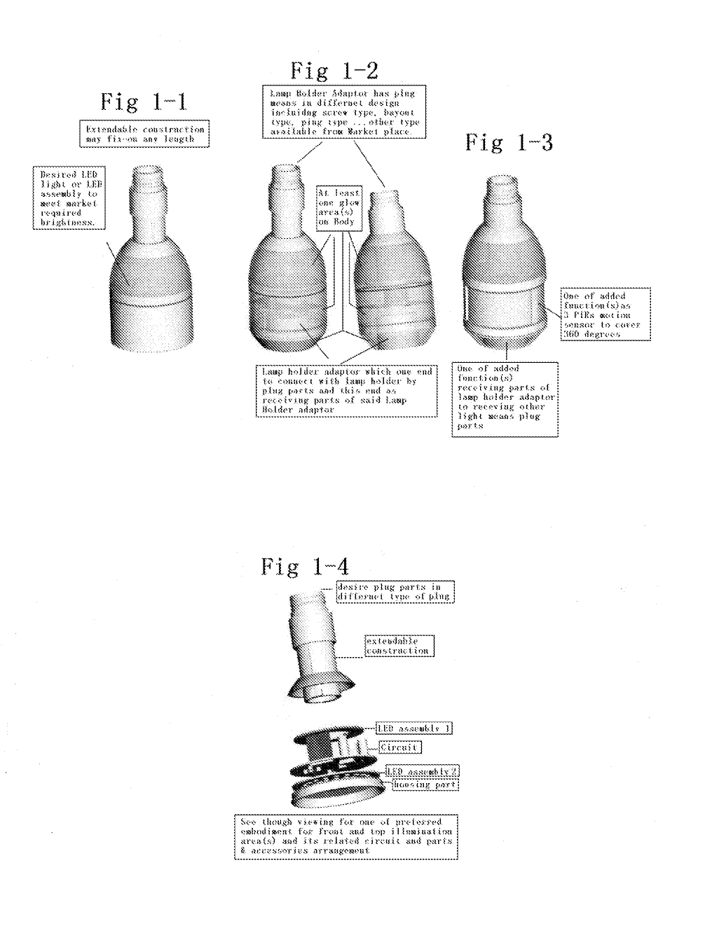

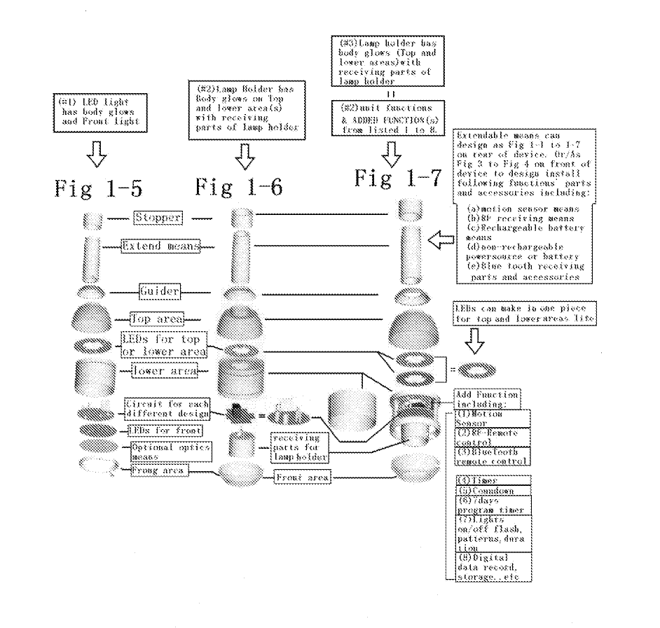

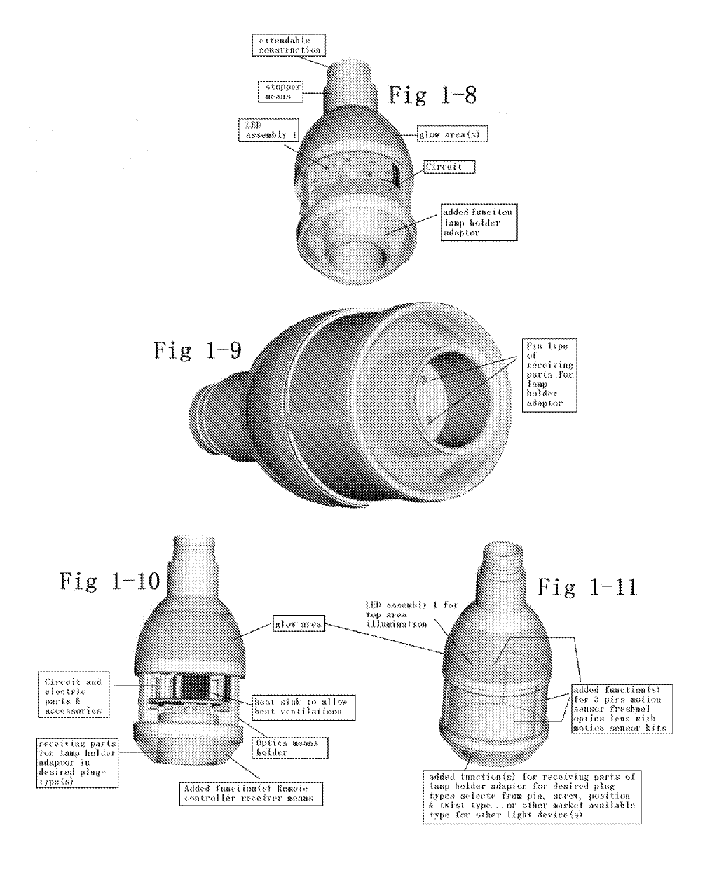

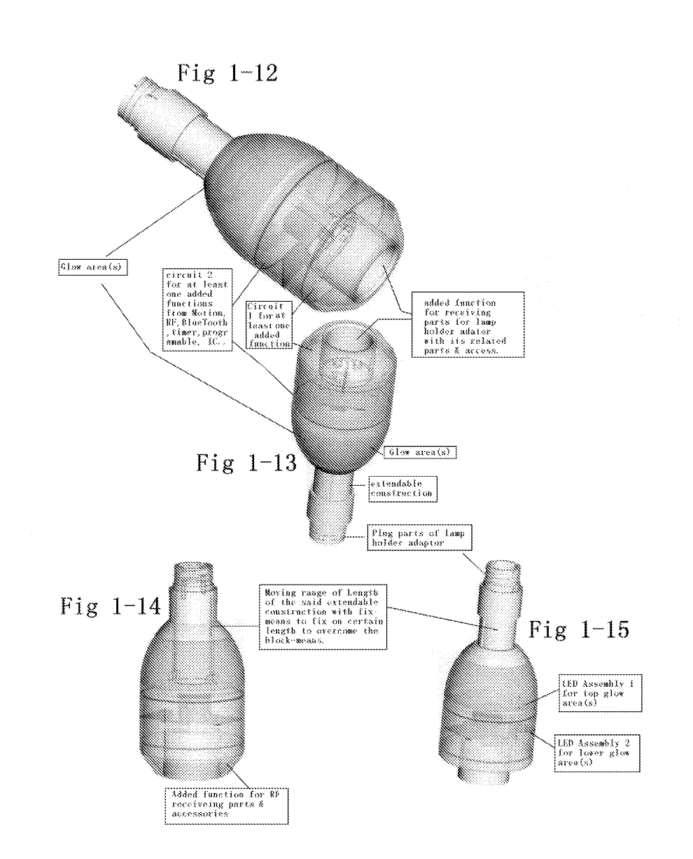

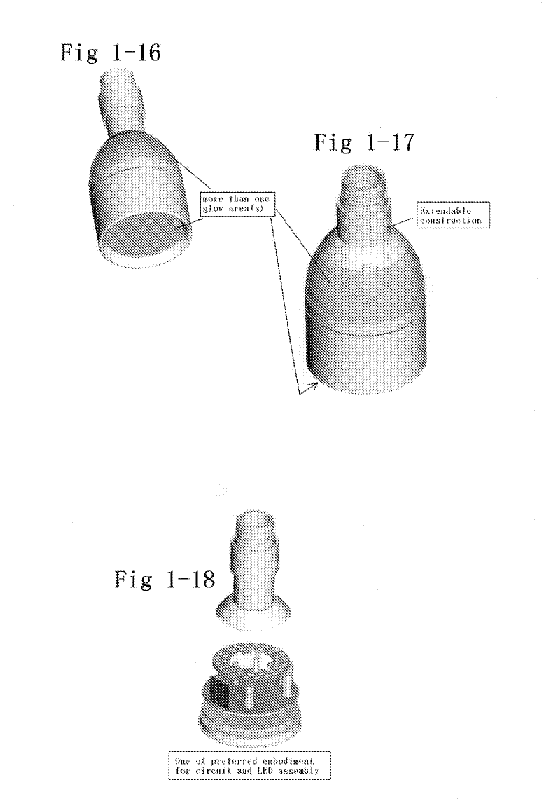

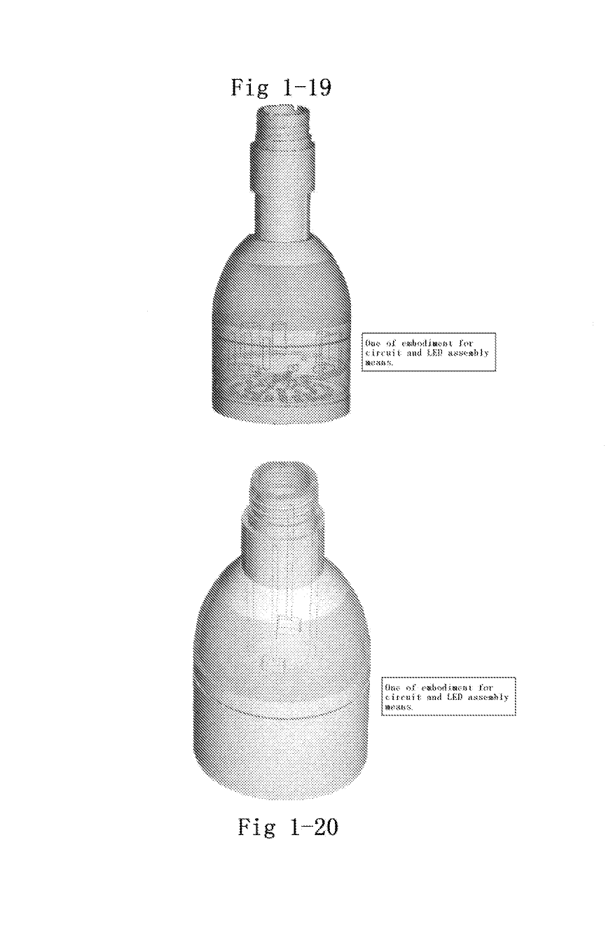

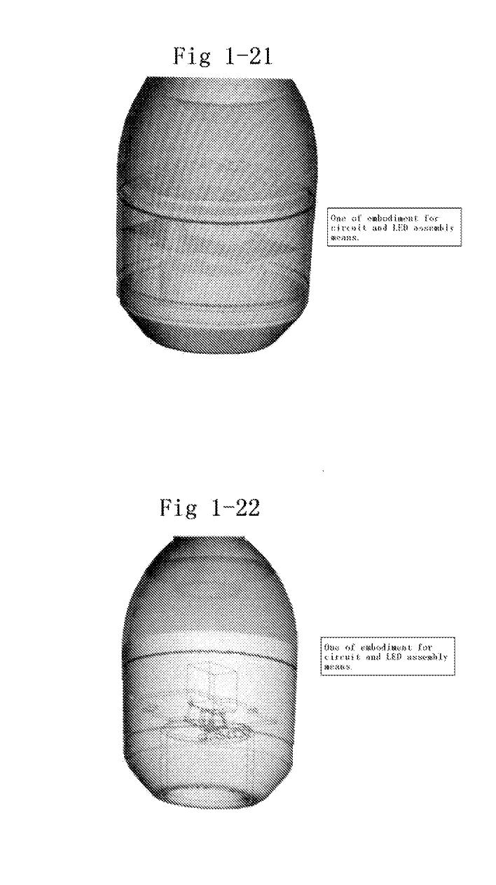

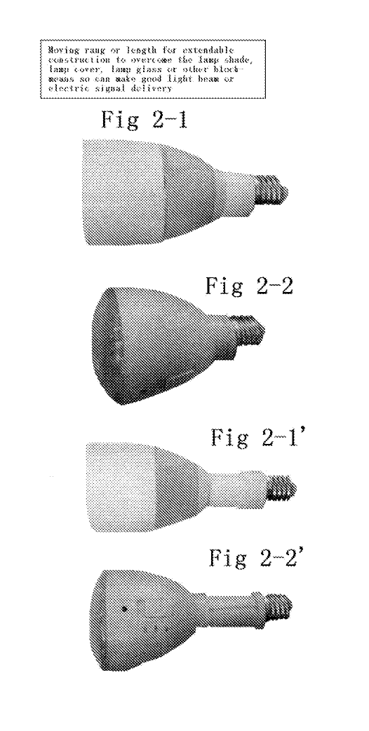

1. From FIG. 1-1 and FIG. 1-2 and FIG. 1-3 disclosure the First group of embodiments has extendable piece(s) to make the said LED Bulb, Lamp Holder, Lamp Holder Adaptor.

2. From FIG. 1-1 and FIG. 1-2 and FIG. 1-3 disclosure the current invention for Lamp Holder, Lamp Holder Adaptor and LED bulb with extendable piece(s) with details selected group parts from above discussed (a) to (z) for preferred embodiment(s).

3. From FIGS. 1-4 to 1-22 Disclosure the all details construction of the conventional LED bulb, Lamp Holder, Lamp Holder Adaptor.

4. From FIG. 2-1 to FIG. 2-4 disclosure the Length difference while extendable piece(s) extended-out v.s. Non-extended difference to overcome the block-means caused by the said Lamp Shade, Lamp Cover, Lamp Glass.

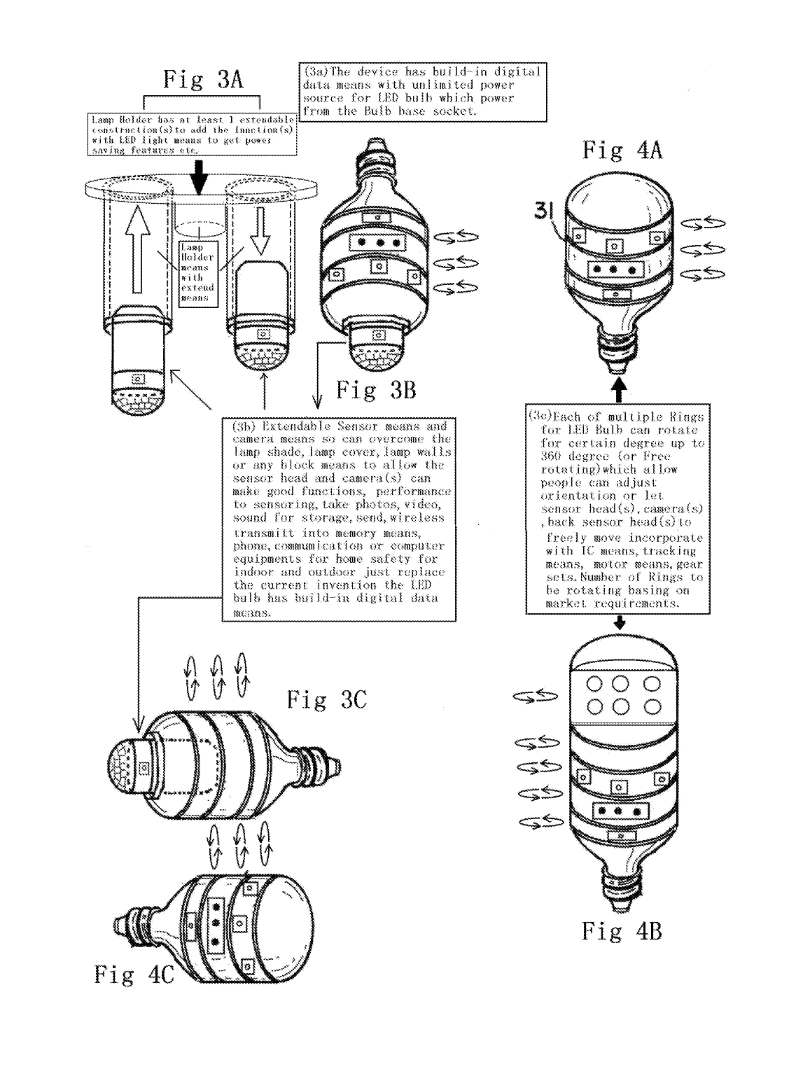

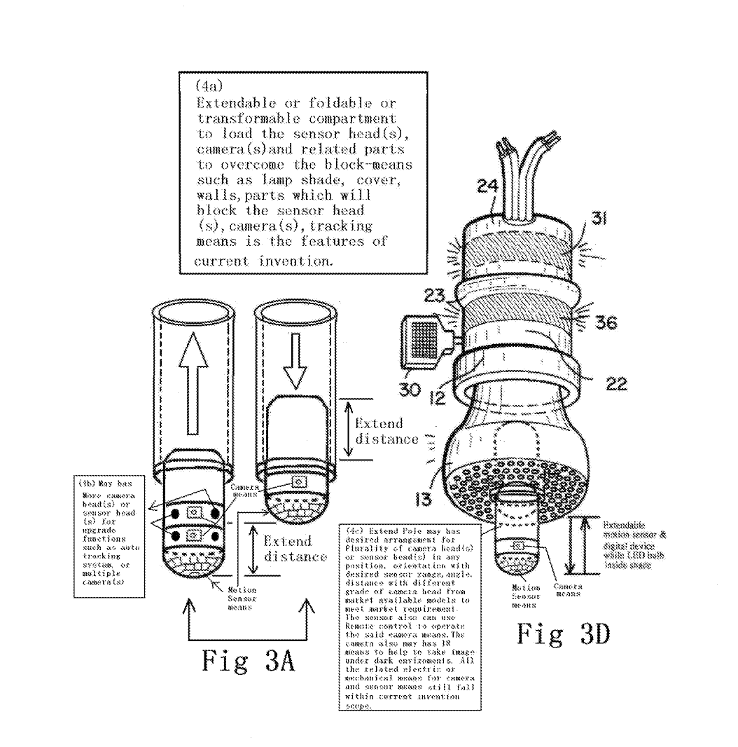

5. From FIG. 3-1 disclosure the Lamp Holder has extendable construction on its base So can add on other functions on those extendable constructions with LED light means.

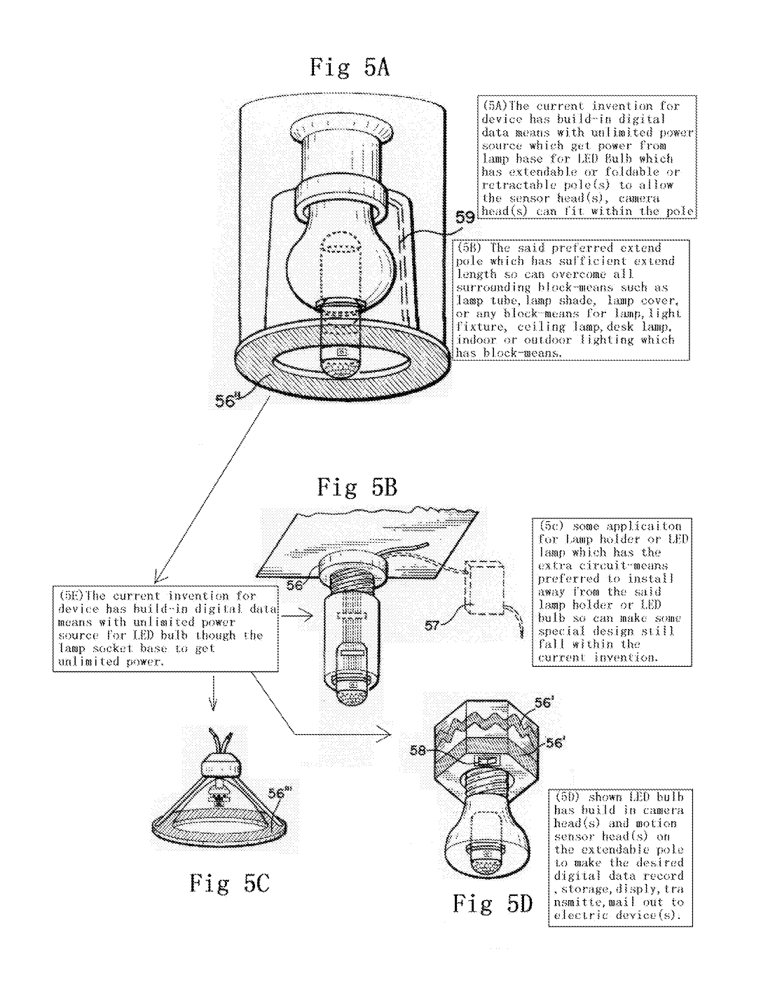

6. From FIG. 3A, 3B, 3C, 3D and FIG. 4A, 4B, 4C and FIG. 5A, 5B, 5C, 5D are co-pending filing for the LED bulb with front extendable piece(s) to install the sensor heads, switch means, photo sensor, RF receiver(s), Bluetooth receiver(s), Timer receiver means, countdown means, 7 days programmable timer means, Other sensor or switch means available from market available parts.

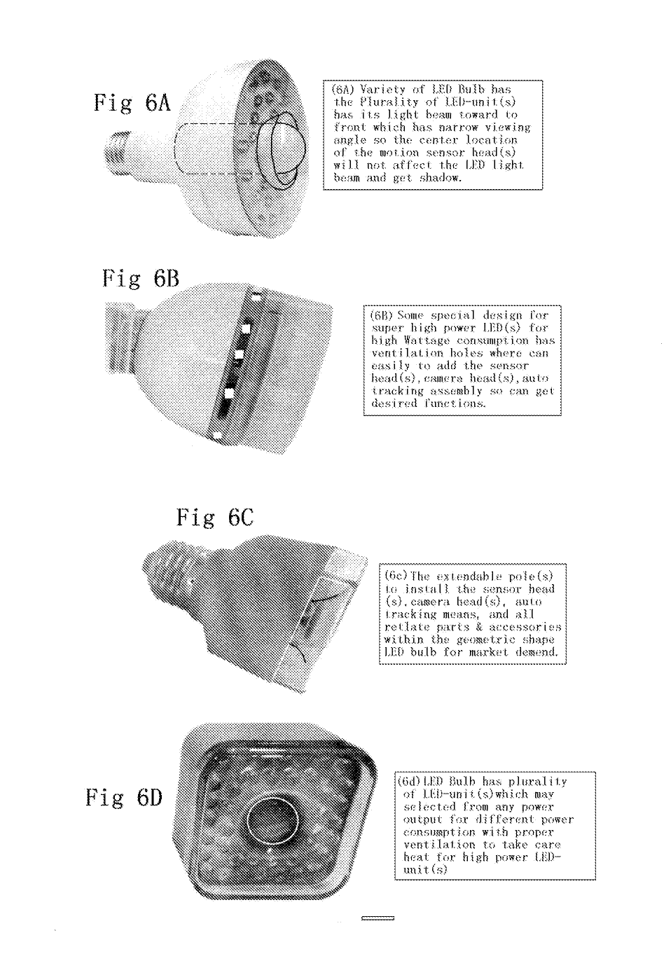

7. From FIG. 6A, 6B, 6C, 6D are co-pending filing for LED bulb with front extendable piece(s) for the LED bulb with front extendable piece(s) compare with non-extendable units which can not overcome the said block-mean(s).

It is appreciated the current invention has all above discussed co-pending or issued patent's drawing, details description and content are still been the parent filing of the current invention and all such drawing, detail description, contents should be still fall within the scope of the current invention and not limited to the current drawing, details description, content.

### DETAILS DESCRIPTION

The current invention related to the “The Device has LED with extendable construction and added functions” which has extendable construction to overcome the lamp cover, lamp shade, lamp glass or other block-means which block out the light beams or electric signal transmitting though.

The current invention further build-in more than one functions on the said “The Device has LED with extendable construction and added functions” which can make sure the light beam or electric signal can overcome all block-means so make the said extendable construction's device give the more than one function to people including the LED bulb, Lamp Holder, Lamp Holder Adaptor(s).

In order to let examiner quickly review all parts and construction and spirit of the current invention, All drawings has brief notes inside rectangular notes for quickly review as below:

From FIG. 1-1 and FIG. 1-2 and FIG. 1-3 disclosure the First group of embodiments has extendable piece(s) to make the said LED Bulb, Lamp Holder, Lamp Holder Adaptor.

From FIG. 1-1 and FIG. 1-2 and FIG. 1-3 disclosure the current invention for Lamp Holder, Lamp Holder Adaptor and LED bulb with extendable piece(s) with details selected group parts from above discussed (a) to (z) for preferred embodiment(s).

From FIGS. 1-4 to 1-22 Disclosure the all details construction of the conventional LED bulb, Lamp Holder, Lamp Holder Adaptor.

From FIG. 2-1 to FIG. 2-4 disclosure the Length difference while extendable piece(s) extended-out v.s. Non-extended difference to overcome the block-means caused by the said Lamp Shade, Lamp Cover, Lamp Glass.

From FIG. 3-1 disclosure the Lamp Holder has extendable construction on its base So can add on other functions on those extendable constructions with LED light means.

From FIG. 3A, 3B, 3C, 3D and FIG. 4A, 4B, 4C and FIG. 5A, 5B, 5C, 5D are co-pending filing for the LED bulb with front extendable piece(s) to install the sensor heads, switch means, photo sensor, RF receiver(s), Bluetooth receiver(s) Timer receiver means, countdown means, 7 days programmable timer means, Other sensor or switch means available from market available parts.

From FIG. 6A, 6B, 6C, 6D are co-pending filing for LED bulb with front extendable piece(s) for the LED bulb with front extendable piece(s) compare with non-extendable units which can not overcome the said block-mean(s).

Also, All these drawing has all following features as the following points.

1. The Device has LED with extendable construction and added functions consist of;

At least has one LED light or LED light assembly for light source.

At least has one extendable construction to allow the said sensor means or switch means or light means overcome the said block-means which may created by the lamp cover, lamp shade, lamp glass, light fixture, stencil, openings, cover, decorative means, lens, or the objects which has equivalent function of the said block-means which cover the light beam, electric signal delivery.

The said Device incorporated desired group combination from the selected parts and accessories to make the body glows light effects lamp holder or Body glows LED bulbs or body glows lamp holder adaptors with extendable construction to install the desired parts and accessories including:

(a) plug parts of LED bulb, lamp holder or lamp holder Adaptor to connect with power source to get power which may has standard screw plug or has tolerance twist-degree to make the orientation, direction, position as requirement or other type of the plug parts including pin-plug, position & twist plug or other market available type of the plug parts.

(b) Multiple parts for illumination area(s)

(c) Extendable piece(s) in geometric shape and size.

(d) Stopper means in geometric shape and size to make stop of extendable piece(s)

(e) Energy storage means for DC energy such as rechargeable or regular batteries.

(f) LED-unit(s) and LED-assembly(s) for desired brightness and size and shape

(g) Circuit means for variety design for desired function(s)

(h) Conductive means and related parts & accessories for delivery electric signal

(i) Construction parts for fit the related mechanical or electric parts & accessories within

(j) motion sensor means

(k) remote control means

(l) blue tooth remote control means

(m) timer means

(n) count down means

(o) 7 days programmable timer means

(p) other switch means or sensor means

(q) Integrated Circuit means (Hereafter as IC)

(r) Digital data record and storage means

(s) Optics means including all kind of lens, stencil, windows, opening, cut-outs, reflective lens, Retro-reflective lens, opaque lens, condense lens, convex lens, concave lens or adjustable focus means lens, or any other optics means apply to LEDs light means

(t) heat sink to make the LEDs heat can be ventilate out of unit

(u) receiving parts & accessories of lamp holder or Lamp Holder Adaptor including the screw base, bayout base, pin-base, position & twist base,

(v) BODY parts for transparent, translucent, opaque, anti-flammable

(w) heat isolating means

(x) light block-out means

(y) switch means or sensor means available from market place

(z) linkable means to make multiple LED lights or Lamp Holders for illumination at the same time.

The improvement including:

The said body glow light performance to make illumination for certain numbers of the areas with the LED light beam within the said the device.

2. The Device has LED with extendable construction and added functions, the said LED bulb or Lamp holder or Lamp Holder Adaptor which apply for Desk Lamp, Table Lamp, Reading Lamp, Mirror Lamp, Floor Lamp, Wall Lamp, Outdoor Lamp, Indoor Lamp, Ceiling Lamp, Chandelier Lamp, Track lighting, Garden lamp, Seasonal lamp, or others lamp available from marketing place.

3. The Device has LED with extendable construction and added functions, the said added functions means the said unit has more than one functions which select from group combination from

(1) motion sensor means

(2) remote control means

(3) blue tooth remote control means

(4) timer means

(5) count down means

(6) 7 days programmable timer means

(7) other switch means or sensor means

(8) Integrated Circuit means (Hereafter as IC)

(9) Digital data record and storage means

(10) More than one areas has LED illumination.

4. The Device has LED with extendable construction and added functions, the said extendable construction may on at least one end or both ends or desired surface(s) of the said LED Bulb or Lamp Holder or Lamp Holder Adaptor.

5. The Device has LED with extendable construction and added functions, the said added function(s) has its related parts & accessories including circuit, electric parts & accessories are fit within the said device compartment(s) or extendable construction space.

6. The Device has LED with extendable construction and added functions, the said LED light, LED assembly may in single side or double side or multiple layer of Printing circuit board with desired LED(s) for shape, specifications, brightness, luminous, power consumption, color, color K-temperatures, viewing angle, size to meet market requirement(s).

8. The Device has LED with extendable construction and added functions, the said Plug parts of the said LED bulb, lamp holder, the lamp holder adaptor which has extra tolerance twist-degree to allow the said LED bulb, lamp holder adaptor to make the sensor means, switch means to aim on desired location, orientation, direction to receive the electric signals.

9. The Device has LED with extendable construction and added functions, the said extendable construction can fix-on different length while incorporate stopper means, lock means to get desired length for the extendable length.

It is appreciated the current invention has all above discussed co-pending or issued patent's drawing, details description and content are still been the parent filing of the current invention and all such drawing, detail description, contents should be still fall within the scope of the current invention and not limited to the current drawing, details description, content.

1. The Device has LED with extendable construction and added functions consist of;
At least has one LED light or LED light assembly for light source.
At least has one extendable construction to allow the said sensor means or switch means or light means overcome the said block-means which may created by the lamp cover, lamp shade, lamp glass, light fixture, stencil, openings, cover, decorative means, lens, or the objects which has equivalent function of the said block-means which cover the light beam, electric signal delivery.
The said Device incorporated desired group combination from the selected parts and accessories to make the body glows light effects lamp holder or Body glows LED bulbs or body glows lamp holder adaptors with extendable construction to install the desired parts and accessories including :
(a) plug parts of LED bulb, lamp holder or lamp holder Adaptor to connect with power source to get power which may has standard screw plug or has tolerance twist-degree to make the orientation, direction, position as requirement or other type of the plug parts including pin-plug, position & twist plug or other market available type of the plug parts.
(b) Multiple parts for illumination area(s)
(c) Extendable piece(s) in geometric shape and size.
(d) Stopper means in geometric shape and size to make stop of extendable piece(s)
(e) Energy storage means for DC energy such as rechargeable or regular batteries.
(f) LED-unit(s) and LED-assembly(s) for desired brightness and size and shape
(g) Circuit means for variety design for desired function(s)
(h) Conductive means and related parts & accessories for delivery electric signal
(i) Construction parts for fit the related mechanical or electric parts & accessories within
(j) motion sensor means
(k) remote control means
(l) blue tooth remote control means
(m) timer means
(n) count down means
(o) 7 days programmable timer means
(p) other switch means or sensor means
(q) Integrated Circuit means (Hereafter as IC)
(r) Digital data record and storage means
(s) Optics means including all kind of lens, stencil, windows, opening, cut-outs, reflective lens, Retro-reflective lens, opaque lens, condense lens, convex lens, concave lens or adjustable focus means lens, or any other optics means apply to LEDs light means
(t) heat sink to make the LEDs heat can be ventilate out of unit
(u) receiving parts & accessories of lamp holder or Lamp Holder Adaptor including the screw base, bayout base, pin-base, position & twist base,
(v) BODY parts for transparent, translucent, opaque, anti-flammable
(w) heat isolating means
(x) light block-out means
(y) switch means or sensor means available from market place
(z) linkable means to make multiple LED lights or Lamp Holders for illumination at the same time.
The improvement including:
The said body glow light performance to make illumination for certain numbers of the areas with the LED light beam within the said the device.

2. The Device has LED with extendable construction and added functions as claim 1, the said LED bulb or Lamp holder or Lamp Holder Adaptor which apply for Desk Lamp, Table Lamp, Reading Lamp, Mirror Lamp, Floor Lamp, Wall Lamp, Outdoor Lamp, Indoor Lamp, Ceiling Lamp, Chandelier Lamp, Track lighting, Garden lamp, Seasonal lamp, or others lamp available from marketing place.

3. The Device has LED with extendable construction and added functions as claim 1, the said added functions means the said unit has more than one functions which select from group combination from
(1) motion sensor means
(2) remote control means
(3) blue tooth remote control means
(4) timer means
(5) count down means
(6) 7 days programmable timer means
(7) other switch means or sensor means
(8) Integrated Circuit means (Hereafter as IC)
(9) Digital data record and storage means
(10) More than one areas has LED illumination.

4. The Device has LED with extendable construction and added functions as claim 1, the said extendable construction may on at least one end or both ends or desired surface(s) of the said LED Bulb or Lamp Holder or Lamp Holder Adaptor.

5. The Device has LED with extendable construction and added functions as claim 1, the said added function(s) has its related parts & accessories including circuit, electric parts & accessories are fit within the said device compartment(s) or extendable construction space.

6. The Device has LED with extendable construction and added functions as claim 1, the said LED light, LED assembly may in single side or double side or multiple layer of Printing circuit board with desired LED(s) for shape, specifications, brightness, luminous, power consumption, color, color K-temperatures, viewing angle, size to meet market requirement(s).

7. The Device has LED with extendable construction and added functions as claim 1, the said Plug parts of the said LED bulb, lamp holder, the lamp holder adaptor which has extra tolerance twist-degree to allow the said LED bulb, lamp holder adaptor to make the sensor means, switch means to aim on desired location, orientation, direction to receive the electric signals.

8. The Device has LED with extendable construction and added functions as claim 1, the said extendable construction can fix-on different length while incorporate stopper means, lock means to get desired length for the extendable length.
